(19) United States
(12) Patent Application Publication
(10) Pub. No.: US 2025/0293349 A1
(43) Pub. Date: Sep. 18, 2025

(54) BATTERY MODULE

(71) Applicant: TOYOTA JIDOSHA KABUSHIKI KAISHA, Toyota-shi, (JP)

(72) Inventors: Taro MATSUSHITA, Toyokawa-shi (JP); Yutaroh GOTOH, Toyota-shi (JP); Masataka OGUSHI, Nisshin-shi (JP); Yukinari TANABE, Okazaki-shi (JP)

(73) Assignee: TOYOTA JIDOSHA KABUSHIKI KAISHA, Toyota-shi (JP)

(21) Appl. No.: 19/040,244

(22) Filed: Jan. 29, 2025

(30) Foreign Application Priority Data
Mar. 15, 2024 (JP) 2024-041639

(51) Int. Cl. H01M 10/658; H01M 10/613; H01M 10/653; H01M 10/6551; H01M 50/204; H01M 50/264; H01M 50/588

(52) U.S. Cl. CPC H01M 10/658; H01M 10/613; H01M 10/653; H01M 10/6551; H01M 50/204; H01M 50/264; H01M 50/588

(57) ABSTRACT

A battery module comprising: a laminated body; a restraining member; and a thermally conductive members interposed between the battery cells and the restraining member. Further, the battery cells includes first and second battery cells, the restraining member includes first and second restraining portions in contact with the thermally conductive member in contact with first and second battery cells, and each of the first and second restraining portions is in contact with the thermally conductive members by skipping at least one battery cell so that a heat transfer from one of the first and second battery cells is not transmitted to another one of the first and second battery cell is suppressed, and a gap or an insulating member is provided between a side surface of the first battery cell and the second restraining portion and between a side surface of the second battery cell and the first restraining portion.

### CROSS-REFERENCE TO RELATED APPLICATION(S)

The present application claims priority to and incorporates by reference the entire contents of Japanese Patent Application No. 2024-041639 filed in Japan on Mar. 15, 2024.

### BACKGROUND

The present disclosure relates to a battery module.

International Publication No. 2018/025567 discloses the battery module in which a plurality of battery cells is stacked, when any of the battery cells abnormal heat generation, in order to suppress the heat from the battery cells which abnormal heat generation to the battery cells adjacent to each other, to increase the thermal resistance of the battery cells adjacent to each other. In the configuration described in International Publication No. 2018/025567, the heat transfer of the battery cell by a band member for holding the battery cell connecting between the pair of end plates is controlled.

### SUMMARY

There is a need for providing a battery module capable of preventing the battery cell and the restraining member from electrically short-circuiting, and suppressing the heat of the adjacent battery cells from affecting the other battery cell.

According to an embodiment, a battery module includes: a laminated body in which a plurality of battery cells and a plurality of heat insulating members are alternately stacked; a restraining member, disposed opposite to a side surface of the laminated body, for restraining the laminated body and extending along a stacking direction of the laminated body; and a thermally conductive members interposed between a side surface of the battery cells and the restraining member and having an insulating property. Further, the plurality of battery cells includes a first battery cell and a second battery cell adjacent to each other, the restraining member includes a first restraining portion in contact with the thermally conductive member in contact with the first battery cell, and a second restraining portion arranged parallel to the first restraining portion and in contact with the thermally conductive member in contact with the second battery cell, each of the first restraining portion and the second restraining portion is in contact with the thermally conductive members by skipping at least one battery cell so that a heat transfer from one of the first battery cell and the second battery cell is not transmitted to another one of the first battery cell and the second battery cell is suppressed, and a gap, preventing the side surface of the battery cells from being in contact with the restraining member, or an insulating member having an insulating property is provided between a side surface of the first battery cell and the second restraining portion and between a side surface of the second battery cell and the first restraining portion.

### BRIEF DESCRIPTION OF THE DRAWINGS

FIG. 1 is a diagram for explaining a battery module in an embodiment;

FIG. 2 is a diagram schematically illustrating a battery module;

FIG. 3 is a diagram for explaining a heat conductive material and an insulating material;

FIG. 4 is a diagram for explaining a structure in which a restraining member and the heat conductive material is in contact;

FIG. 5 is a diagram for explaining a case where heat is moved from the battery cell which generates heat;

FIG. 6 is a diagram for explaining a structure in which a slit is provided in the restraining member;

FIG. 7 is a diagram for explaining a structure in which a cross member and the heat conductive material provided on a lower case of the battery pack is in contact;

FIG. 8 is a diagram for explaining a structure in which the restraining member is arranged three on the side surface of one side of the battery cell; and

FIG. 9 is a diagram for explaining a structure in which three restraining members are arranged on one side.

### DETAILED DESCRIPTION

In the configuration described in International Publication No. 2018/025567, since the metal restraining member is a structure in direct contact with the cell case of the battery cell, the cell case and the restraining member of the battery cell will be short-circuited. Therefore, there is a possibility that heat generation due to the short circuit.

Hereinafter, a battery module in the embodiment of the present disclosure will be specifically described. Note that the present disclosure is not limited to the embodiments described below.

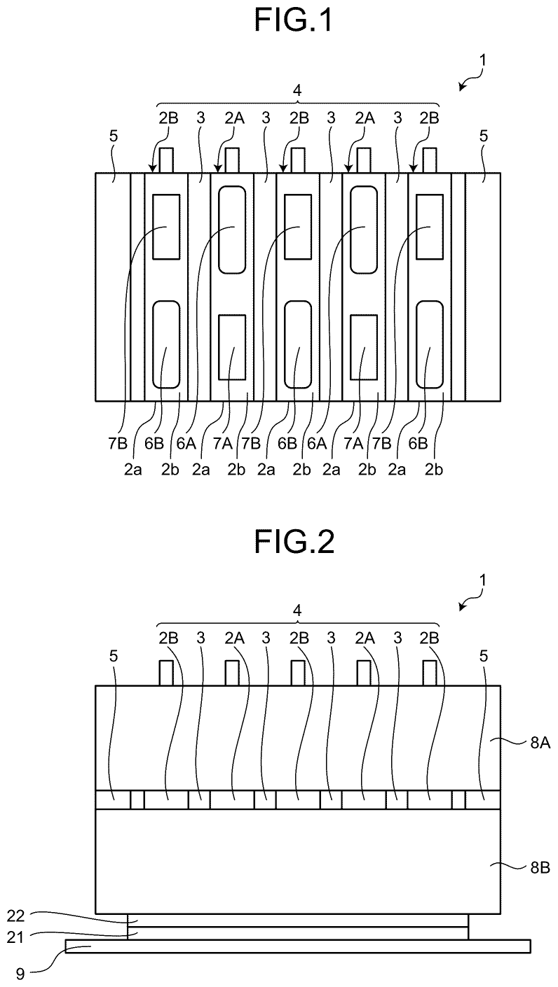

As illustrated in FIG. 1, the battery module 1 includes a laminated body 4 in which a plurality of battery cells 2 and a plurality of heat insulating members (heat insulating materials) 3 are stacked alternately arranged, a pair of end plates 5 sandwiching the laminated body 4 from both sides in the stacking direction, a heat conductive material 6 having an insulating property, an insulating member (insulating material) 7 having a heat insulating property. As illustrated in FIG. 2, the battery module 1 includes a restraining band 8 that restrains the laminated body 4. In the battery module 1, the battery cell 2 is cooled from the lower surface 2a of the battery cell 2 by the cooler 21. The cooler 21 cools the lower surface 2a of the cell 2 through a thermally conductive member 22. A thermally conductive member 22 is interposed between the lower surface 2a of the cell 2 and the cooler 21. The battery module 1 is housed inside the lower case 9. The battery module 1 is accommodated in the case of the battery pack (pack case). The pack case includes a lower case 9 for accommodating the battery module 1.

As illustrated in FIG. 1, in the laminated body 4, between the battery cells 2 adjacent to each other are insulated by the heat insulating material 3. A pair of end plates 5 are arranged at both ends of the laminated body 4 in the stacking direction. Insulation is provided between the end plate 5 and the battery cells 2. As illustrated in FIG. 2, the laminated body 4 is constrained by a restraining band 8 in a state of being compressed in the stacking direction by a compressive load applied from a pair of end plates 5. The restraining band 8 is a restraining member both end portions in the stacking direction are fixed to a pair of end plates 5. The end plate 5 and the restraining band 8 are integrated by bolt fastening.

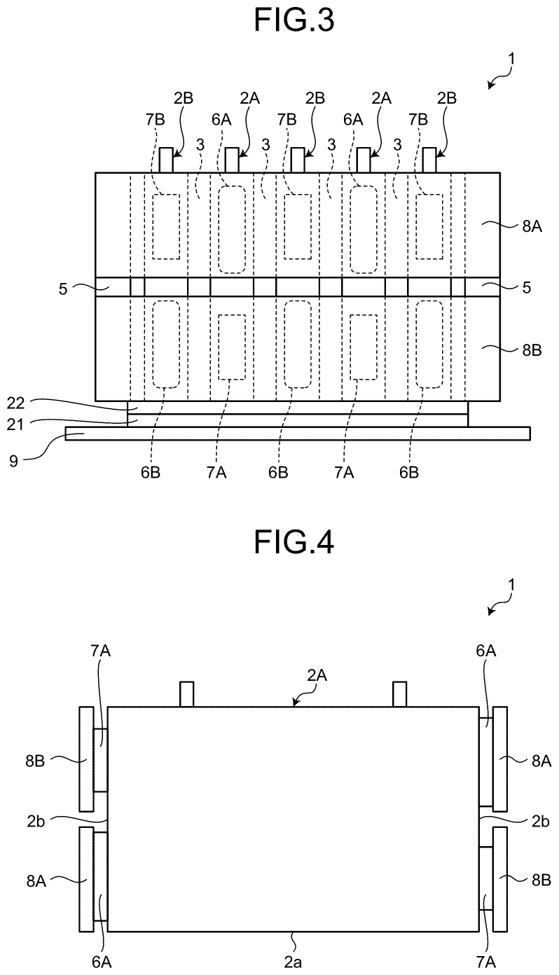

As illustrated in FIGS. 2 to 4, the restraining band 8 is disposed at a position facing the side surface of the laminated body 4, a side band extending along the stacking direction of the laminated body 4. In the battery module 1 restraining band 8 is provided at a position facing the side surfaces of both sides of the stack 4. The restraining strap 8 faces the side 2b of the cell 2. On the side surface 2b of the battery cell 2, the thermal conductive material 6 and the insulating member 7 is provided in the upper and lower two stages. A thermally conductive member (thermally conductive material) 6 and an insulating member 7 are interposed between the side 2b of the cell 2 and the restraining strap 8. The restraining band 8 forms a heat dissipation path for radiating heat from the battery cell 2.

The heat conductive material 6 is a plate-like member provided on the side surface 2b of the battery cell 2, to form a heat path for transferring the heat of the battery cell 2 to the restraining band 8. The thermally conductive member 6 is interposed between the side 2b of the cell 2 and the restraining strap 8. As illustrated in FIG. 4, the thermally conductive member 6 is in surface contact with the side surface 2b of the cell 2 and in surface contact with the restraining band 8. The heat conductive material 6 has a sufficient thermal conductivity to draw heat at the time of abnormal heat generation of the battery cell 2. Thermal conductive material 6, for example, the thermal conductivity is 1W/mk or more, and the electric resistivity is 10 MΩ or more.

The insulating member 7 is a plate-shaped member provided on the side surface 2b of the battery cell 2, to insulate between the battery cell 2 and the restraining band 8. The insulating member 7 is interposed between the side 2b of the cell 2 and the restraining band 8. The insulating member 7 is composed of a member having high thermal resistance, for example, mica.

In the battery module 1 configured in this way, in order to prevent the battery cell 2 adjacent to the battery cell 2 from smoking when any of the battery cells 2 emits smoke, without inducing another heating mode, the heat from the battery cell 2 that emits smoke to other than the adjacent battery cells 2 It has a heat dissipation path. The battery module 1 has a structure in which the battery cell 2 and the restraining band 8 are brought into contact with the heat conductive material 6 by at least skip one so that heat of the battery cell 2 does not go around from the restraining band 8 to the adjacent battery cell.

The plurality of battery cells 2 includes a first battery cell 2A and a second battery cell 2B adjoining the first battery cell 2A. The plurality of battery cells 2 includes the first battery cell 2A and the second battery cell 2B adjacent to each other. The thermally conductive member 6 includes a first thermally conductive member 6A that contacts the first battery cell 2A and a second thermally conductive member 6B that contacts the second battery cell 2B. The insulating member 7 includes a first insulating member 7A that contacts the first battery cell 2A and a second insulating member 7B that contacts the second battery cell 2B. The restraining band 8 includes a first restraining band 8A and a second restraining band 8B.

On the side surface 2b of the first battery cell 2A, the first thermal conductive material 6A and the first insulating member 7A is provided in the upper and lower stages (two stages). On the side surface 2b of the second battery cell 2B, the second thermal conductive material 6B and the second insulating member 7B is provided in the upper and lower stages. The first restraining-band 8A contacts the first thermally conductive member 6A and the second insulating member 7B. The first restraining-band 8A alternately contacts the first thermal conductive material 6A and the second insulating member 7B in the stacking direction. The second restraining band 8B is arranged parallel to the first restraining band 8A and contacts the second thermal conductive material 6B and the first insulating member 7A. The second restraining-band 8B alternately contacts the second thermally conductive member 6B and the first insulating member 7A in the stacking direction. In the restraining band 8, the first restraining band 8A is the first restraining portion, the second restraining band 8B is the second restraining portion. Incidentally, when not particularly distinguished between the first and second are described omitted A and B of the code.

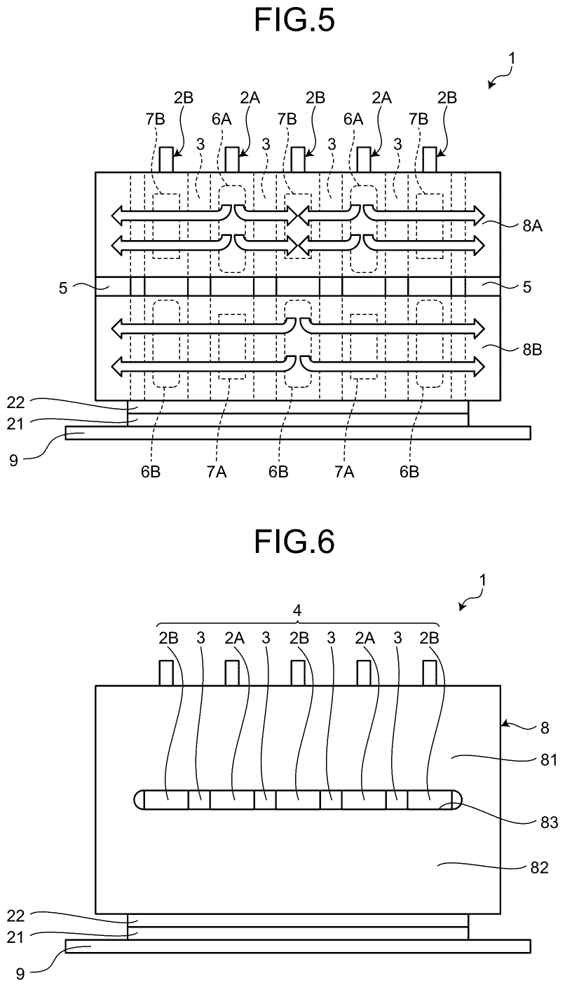

The first restraining-band 8A forms a heat dissipation path that radiates heat from the first cell 2A to other than the neighboring cells. As illustrated in FIG. 5, the first restraining-band 8A forms a heat radiation path such that heat of the first battery cell 2A received from the first heat conductive material 6A does not enter the neighboring second battery cell 2B. The second restraining-band 8B forms a heat dissipation path that radiates heat from the second cell 2B to other than the neighboring cells. The second restraining-band 8B forms a heat radiation path such that heat of the second battery cell 2B received from the second heat conductive material 6B does not enter the neighboring first battery cell 2A.

The first restraining band 8A and the second restraining band 8B, respectively, so that the heat of one of the battery cells 2 in the first battery cell 2A and the second battery cell 2B adjacent to each other is not transmitted to the other of the battery cells 2 through the restraining band 8, contacts the heat conductive material 6 by skipping at least one battery cell 2. As illustrated in FIG. 5, an insulating member 7 is provided in a portion where a heat path from the battery cell 2 to the restraining band 8 is not desired. Between the first restraining-band 8A and the second battery cell 2B, a portion where the thermal conductive material 6 is not provided is provided.

Between the second restraining-band 8B and the first battery cell 2A, a portion where the thermal conductive material 6 is not provided is provided. The insulating member 7 is provided in a portion where the heat conductive material 6 is not provided. Thus, if any one of the battery cells 2 emits smoke, the heat of the battery cell 2 that emits smoke is not heat input to the adjacent cells.

In the battery module 1, when one side of the laminated body 4 has a structure as illustrated in FIG. 5, the other side of the laminated body 4 has a structure upside down from the structure illustrated in FIG. 5. Taking the first battery cell 2A as an example, as illustrated in FIG. 4, on one side surface 2b of the first battery cell 2A, the first thermal conductive material 6A is disposed in the upper stage, and the first insulating member 7A is disposed in the lower stage. In this instance, on the other side surface 2b of the first battery cell 2A, the first insulating member 7A is disposed in an upper stage, and the first thermal conductive material 6A is disposed in a lower stage. This arrangement is also applicable to the second cell 2B.

As described above, according to the embodiment, in the battery module 1, when any of the battery cells 2 generates abnormal heat, it is possible to suppress the heat from being transferred from the battery cells 2 to the adjacent battery cells 2, and to prevent a short circuit between the battery cells 2 and the restraining band 8. Thus, it is possible to suppress the thermal chain by a plurality of battery cells 2.

The insulating member 7 may not necessarily be provided. For example, the portion where the thermal conductive material 6 is not provided, only a gap where the side 2b and the restraining band 8 of the battery cell 2 does not contact may be provided. A gap in which the battery cell 2 and the restraining band 8 do not contact or an insulating member 7 may be provided in a portion in which the heat conductive material 6 is not provided.

The restraining band 8 is not limited to a structure consisting of two members including a first restraining band 8A and a second restraining band 8B. The restraining band 8, as illustrated in FIG. 6, may be constituted by a single member. The restraining band 8 illustrated in FIG. 6 includes a first restraining portion 81, a second restraining portion 82, and a slit 83. The first restraining portion 81 forms a heat radiation path for radiating heat of the first cell 2A in the same manner as the first restraining-band 8A. The second restraining portion 82 forms a heat radiation path for radiating heat from the second cell 2B in the same manner as the second restraining-band 8B. The first restraining portion 81 and the second restraining portion 82 are disposed at positions facing the side surface of the laminated body 4, extending in the stacking direction so as to cross all of the battery cells 2 of the laminated body 4. On one side surface side of the laminated body 4, the first restraining portion 81 is disposed on the upper side of the laminated body 4, the second restraining portion 82 is disposed on the lower side of the laminated body 4. The slit 83 extends along the stacking direction in the central portion in the height direction in a manner that the first restraining portion 81 and the second restraining portion are separate from each other to form the upper and lower stages (two stages). The slits 83 extend across the entire side of the stack 4. It is possible to prevent heat conduction from the first restraining portion 81 to the second restraining portion 82 by the slit 83, and heat conduction from the second restraining portion 82 to the first restraining portion 81. The restraining band 8 may be divided, it may be a structure in which the slit 83 is empty. In other words, it is sufficient to divide the thermal mass.

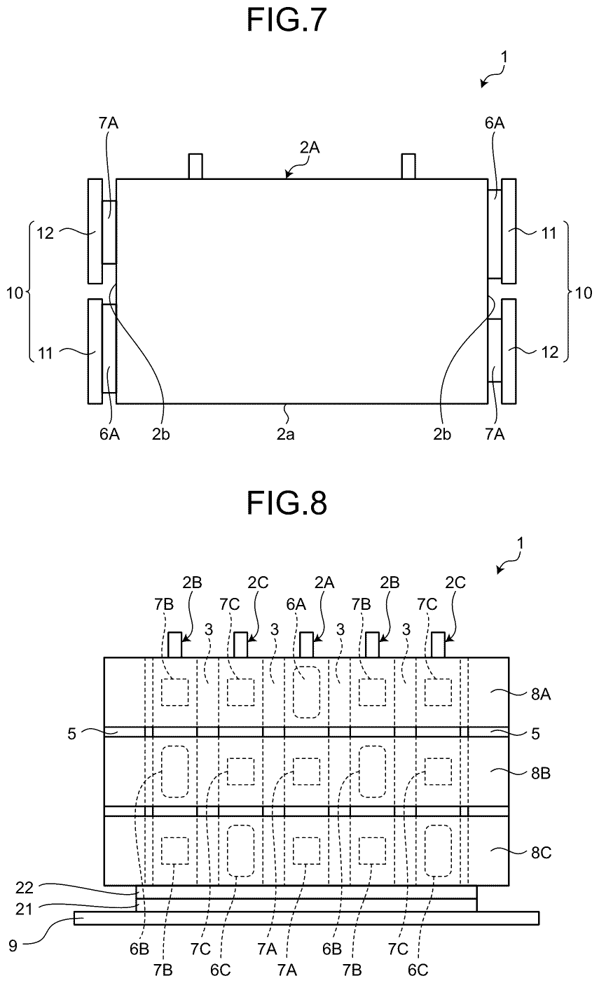

Further, in the battery module 1, the restraining member for restraining the laminated body 4 is not limited to the restraining band 8. The restraining member may be a cross member 10 of the lower case 9. The lower case 9 is provided with the cross member 10 for partitioning the accommodation chamber of the battery module 1. The cross member 10 is integrated with the lower case 9. As illustrated in FIG. 7, the cross-member 10 is disposed at a position facing the side 2b of the battery cell 2. In the battery module 1 of the modified example, the cross member 10 of the pack case instead of the restraining band 8 forms a heat dissipation path. The restraining member to which the heat conductive material 6 is in contact is not limited to the restraining band 8. The heat dissipation path for radiating heat of the battery cell 2 which is heat input from the heat conductive material 6 may be a member other than the restraining band 8. The cross member 10 functions as a restraining member for restraining the laminated body 4.

The cross member 10 is disposed at a position facing the side surface of the stack 4, extending in the stacking direction so as to cross all of the battery cells 2 of the stack 4. The cross member 10 includes a first cross section 11, and a second cross section 12. A slit is provided between the first cross portion 11 and the second cross portion 12 in the height direction. On one side surface side of the laminated body 4, the first cross section 11 is disposed on the upper side of the laminated body 4, the second cross section 12 is disposed on the lower side of the laminated body 4. The slit extends along the stacking direction in the central portion in the height direction so as to separate the first cross portion 11 and the second cross portion 12 in the upper and lower stages. The slit extends across the entire sides of the stack 4. It is possible to prevent heat conduction from the first cross portion 11 to the second cross portion 12 by the slit, and heat conduction from the second cross portion 12 to the first cross portion 11. In the cross member 10, the first cross portion 11 is a first restraining portion, the second cross portion 12 is a second restraining portion.

Further, the battery cells 2 adjacent to the same restraining band 8 may be any structure that does not contact at the same time, the arrangement pattern of the heat conductive material 6 is not particularly limited. As illustrated in FIG. 4, the thermally conductive member 6 may be arranged differently in the side surface 2b on both sides of the cell 2. As illustrated in FIG. 8, the constraining band 8 may be a structure divided into three.

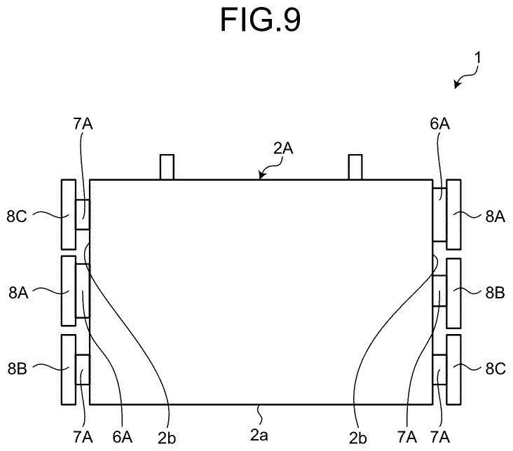

As illustrated in FIGS. 8 and 9, in the battery module 1 of the modified example, the restraining band 8 has a structure in which the upper and lower three stages. The restraining band 8 includes a first restraining band 8A, a second restraining band 8B, and a third restraining band 8C. One thermally conductive member 6 and two insulating materials 7 are provided in three upper and lower stages on one side 2b of the battery cell 2. The plurality of battery cells 2 includes a third battery cell 2C. In this instance, the first battery cell 2A is adjacent to the second battery cell 2B and adjacent to the third battery cell 2C. The second battery cell 2B is adjacent to the first battery cell 2A, and adjacent to the third battery cell 2C. The third battery cell 2C is adjacent to the second battery cell 2B, and adjacent to the first battery cell 2A. The third restraining-band 8C forms a heat dissipation path that radiates heat from the third cell 2C. On the side surface 2b of the third battery cell 2C, the third thermal conductive material 6C and the third insulating member 7C are provided. The third thermal conductive material 6C and the third insulating member 7C are interposed between the side 2b of the third battery cell 2C and the third restraining-band 8C. The third constrained-band 8C is the third constrained portion.

Further, on the lower surface of the laminated body 4, the cooler 21 and the thermal mass having the same effect as the cooler 21 may be provided. The cooler 21 and the thermal mass may be disposed inside the lower case 9, or may be disposed below the lower case 9.

In the present disclosure, it is possible to prevent the heat of the adjacent battery cells from affecting the other battery cell while preventing the battery cell and the restraining member from electrically short-circuiting.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A battery module comprising:
a laminated body in which a plurality of battery cells and a plurality of heat insulating members are alternately stacked;
a restraining member, disposed opposite to a side surface of the laminated body, for restraining the laminated body and extending along a stacking direction of the laminated body; and
a thermally conductive members interposed between a side surface of the battery cells and the restraining member and having an insulating property, wherein
the plurality of battery cells includes a first battery cell and a second battery cell adjacent to each other,
the restraining member includes
a first restraining portion in contact with the thermally conductive member in contact with the first battery cell, and
a second restraining portion arranged parallel to the first restraining portion and in contact with the thermally conductive member in contact with the second battery cell,
each of the first restraining portion and the second restraining portion is in contact with the thermally conductive members by skipping at least one battery cell so that a heat transfer from one of the first battery cell and the second battery cell is not transmitted to another one of the first battery cell and the second battery cell is suppressed, and
a gap, preventing the side surface of the battery cells from being in contact with the restraining member, or an insulating member having an insulating property is provided between a side surface of the first battery cell and the second restraining portion and between a side surface of the second battery cell and the first restraining portion.

2. The battery module according to claim 1, wherein
the insulating member is provided between the side surface of the first battery cell and the second restraining portion and between the side surface of the second battery cell and the first restraining portion,
the insulating member is interposed between the side surface of the battery cells and the restraining member,
the first restraining portion is in alternately contact, in the stacking direction, with the thermally conductive member, which is in contact with the first battery cell, and the heat insulating member, which is in contact with the second battery cell, and
the second restraining portion is in alternately contact, in the stacking direction, with the thermally conductive member, which is in contact with the second battery cell, and the heat insulating member, which is in contact with the first battery cell.

3. The battery module according to claim 2, wherein
the thermally conductive member has a thermal conductivity of 1 W/mk or more, and an electric resistivity of 10 MΩ or more.

4. The battery module according to claim 3, further comprising a pair of end plates sandwiching, disposed on both end sides of the laminated body in the stacking direction, sandwiching the laminated body from both sides of the laminated body in the stacking direction, wherein
the restraining member is a band member both end portions thereof in the stacking direction are fixed to the pair of end plates.

5. The battery module according to claim 3, wherein
the laminated body is housed in a lower case of the battery pack, and
the restraining member is a cross member integrated into the lower case.
